(19) United States
(12) Patent Application Publication
(10) Pub. No.: US 2024/0121665 A1
(43) Pub. Date: Apr. 11, 2024

(54) DISTRIBUTED RESOURCE ALLOCATION IN CELL-FREE MIMO WITH ONE-ROUND MESSAGE EXCHANGE

(71) Applicant: Apple Inc., Cupertino, CA (US)

(72) Inventors: Danila Zaev, Munich (DE); Ayman F. Naguib, Cupertino, CA (US)

(21) Appl. No.: 18/372,488

(22) Filed: Sep. 25, 2023

Related U.S. Application Data
(60) Provisional application No. 63/409,704, filed on Sep. 23, 2022.

(51) Int. Cl. H04W 28/086; H04L 1/1812; H04W 28/18

(52) U.S. Cl. CPC H04W 28/0862; H04L 1/1812; H04W 28/18

(57) ABSTRACT

Disclosed are methods, systems, and computer-readable medium to perform operations including: a method for distributed coordination between L2 nodes. In one aspect, the method can include actions of detecting, by a first L2-node, an occurrence of a triggering condition, determining, by the first L2-node, a plurality of message recipients, wherein each message recipient of the plurality of recipients is another L2-node, determining, by the first L2-node, a message type based on (i) the detected occurrence of the triggering condition and (ii) the determined plurality of message recipients, and transmitting, by the first L2-node, a message of the determined message type to each of the plurality of message recipients.

### CLAIM OF PRIORITY

This application claims priority under 35 U.S.C. § 119(e) to U.S. Patent Application Ser. No. 63/409,704 filed on Sep. 23, 2022, the entire contents of which are hereby incorporated by reference.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

In accordance with one innovative aspect of the present disclosure, a method for distributed coordination between L2 nodes is disclosed. In one aspect, the method can include actions of detecting, by a first L2-node, an occurrence of a triggering condition, determining, by the first L2-node, a plurality of message recipients, wherein each message recipient of the plurality of recipients is another L2-node, determining, by the first L2-node, a message type based on (i) the detected occurrence of the triggering condition and (ii) the determined plurality of message recipients, and transmitting, by the first L2-node, a message of the determined message type to each of the plurality of message recipients.

Aspects of the implementations are directed to a method for distributed coordination between L2 nodes, the method including detecting, by a first L2-node, an occurrence of a triggering condition; determining, by the first L2-node, a plurality of message recipients, wherein each message recipient of the plurality of recipients is another L2-node; determining, by the first L2-node, a message type based on (i) the detected occurrence of the triggering condition and (ii) the determined plurality of message recipients; and transmitting, by the first L2-node, a message of the determined message type to each of the plurality of message recipients.

Aspects of the implementations are directed to one or more processors comprising circuitry to execute one or more instructions that, when executed, cause an L2-node to perform the operations including detecting, by a first L2-node, an occurrence of a triggering condition; determining, by the first L2-node, a plurality of message recipients, wherein each message recipient of the plurality of recipients is another L2-node; determining, by the first L2-node, a message type based on (i) the detected occurrence of the triggering condition and (ii) the determined plurality of message recipients; and transmitting, by the first L2-node, a message of the determined message type to each of the plurality of message recipients.

Aspects of the implementations are directed to an L2-node that includes one or more processors; and one or more memory devices storing instructions that, when executed, cause the one or more processors to perform the operations. The operations can include detecting, by a first L2-node, an occurrence of a triggering condition; determining, by the first L2-node, a plurality of message recipients, wherein each message recipient of the plurality of recipients is another L2-node; determining, by the first L2-node, a message type based on (i) the detected occurrence of the triggering condition and (ii) the determined plurality of message recipients; and transmitting, by the first L2-node, a message of the determined message type to each of the plurality of message recipients.

In some implementations, the triggering condition is a preconfigured period or a particular triggering event, and the determined plurality of message recipients are L2-nodes within the same neighborhood as the first L2-node.

In some implementations, the particular triggering event can include one of a change of UE state or a novel UE connecting to at least one of the L2-nodes.

In some implementations, determining, by the first L2-node, a message type based on (i) the detected occurrence of the triggering condition and (ii) the determined plurality of message recipients includes selecting a message type that indicates information about active UEs within the neighborhood, wherein the information indicated by the selected message type comprises one or more of the following types of information: a list of connected UEs, RRC state, SRS-based channel measurement information or the estimated covariance matrix of the channel for UEs in RRC active state, an RLC buffer status for UEs in RRC active state, HARQ processes information, a scheduling priority for UEs in RRC active state, link adaptation offsets for UEs in RRC active state, a CQI for UEs in RRC active state, and a list of RLC PDU IDs or a hash function result of RLC PDU data for the selected UEs.

In some implementations, the triggering condition is a preconfigured period or a particular triggering event, and the determined plurality of message recipients are L2-nodes within a same extended neighborhood as the first L2-node.

In some implementations, the particular triggering event can include a change of UE state or a novel UE joined the extended neighborhood.

In some implementations, determining, by the first L2-node, a message type based on (i) the detected occurrence of the triggering condition and (ii) the determined plurality of message recipients includes selecting a message type that indicates information about active UEs within the neighborhood, wherein the information indicated by the selected message type comprises one or more of the following types of information: an L2-node order value, a list of L2-nodes in the neighborhood, and a potential coordination benefit value.

In some implementations, the potential coordination benefit value is calculated for a potential coordination option between a considered L2-node and each of L2-nodes from the neighborhood.

In some implementations, the triggering condition is a (i) a preconfigured period at L2 nodes with a lowest order value or (ii) a predetermined event, and the determined plurality of message recipients are L2-nodes that are leaders and followers in a same neighborhood as the first L2-node.

In some implementations, the predetermined event is after receipt of a particular message type from every L2-node in the extended neighborhood of the first L2-node with a lower order value than the order value of the first L2-node.

In some implementations, the particular message type comprises one or more of the following types of information: indication of the leader and follower status for each node in the neighborhood and the considered node itself, and for each follower node in the neighborhood, an indication of its leader node.

In some implementations, determining, by the first L2-node, a message type based on (i) the detected occurrence of the triggering condition and (ii) the determined plurality of message recipients includes selecting a message type that indicates information about active UEs within the neighborhood, wherein the information indicated by the selected message type comprises one or more of the following types of information: indication of the leader and follower status for each node in the neighborhood and the considered node itself, and for each follower node in the neighborhood, an indication of its leader node.

In some implementations, leaders and followers are selected based on a coordinate benefit value provided by another message type.

In some implementations, the other message type comprises one or more of the following types of information: an L2-node order value, a list of L2-nodes in the neighborhood, and a potential coordination benefit value.

In some implementations, the triggering condition is every predefined scheduling period, and the determined plurality of message recipients is the indicated leader node of the first L2-node.

In some implementations, determining, by the first L2-node, a message type based on (i) the detected occurrence of the triggering condition and (ii) the determined plurality of message recipients includes selecting a message type that indicates information about active UEs within the neighborhood, wherein the information indicated by the selected message type comprises one or more of the following types of information: a list of connected UEs, RRC state, an RLC buffer status for UEs in RRC active state, a HARQ processes information, a scheduling priority for UEs in RRC active state, a link adaptation offsets for UEs in RRC active state, and a relevant CSI information.

In some implementations, the triggering condition is every predefined scheduling period, and the determined plurality of message recipients are (i) each follower node within the same neighborhood or (ii) the entire neighborhood of the each follower.

In some implementations, determining, by the first L2-node, a message type based on (i) the detected occurrence of the triggering condition and (ii) the determined plurality of message recipients includes selecting a message type that indicates information about active UEs within the neighborhood, wherein the information indicated by the selected message type comprises one or more of the following types of information: resource allocation, rank, MCS for each UE, and a HARQ process indication if HARQ retransmission is scheduled.

Other aspects includes apparatuses, systems, and computer programs for performing the actions of the aforementioned method.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE DRAWINGS

FIG. 1 illustrates a wireless network, according to some implementations.

FIG. 2 illustrates an example of a system for cell-free massive MIMO, in accordance with one aspect of the present disclosure.

FIG. 3A illustrates an example of a system diagram depicting a type of coordinated beamforming referred to as joint beamforming, in accordance with one aspect of the present disclosure.

FIG. 3B illustrates an example of a system diagram depicting a type of coordinated beamforming referred to as interference-avoiding beamforming, in accordance with one aspect of the present disclosure.

FIG. 4 illustrates an example of a system diagram depicting an example of joint-beamforming with a UE served by a single L2-node and multiple radio units (RUs), in accordance with one aspect the present disclosure.

FIG. 5 illustrates an example of a system diagram depicting an example of joint-beamforming with a UE served by multiple L2-nodes and multiple RUs, in accordance with one aspect of the present disclosure.

FIG. 6 is a flowchart of an example of a process for distributed coordination between L2 nodes, in accordance with one aspect of the present disclosure.

FIG. 7 is a flow diagram of an example of a Message Type 3 exchange, in accordance with one aspect of the present disclosure.

FIG. 8 is an example of a process for scheduling and scheduling adjustment procedures, in accordance with one aspect of the present disclosure.

FIG. 9 illustrates an example of a graph model for distributed unit (DU) coordination, in accordance with one aspect of the present disclosure.

FIG. 10 illustrates definitions for leading and following DUs, in accordance with one aspect of the present disclosure.

FIG. 11 illustrates a mathematical model of the coordination problem, in accordance with one aspect of the present disclosure.

FIG. 12 illustrates an example of distributed coordination in local communications, in accordance with one aspect of the present disclosure.

FIG. 13 illustrates an example of a distributed solution of the coordination problem, in accordance with one aspect of the present disclosure.

FIG. 14 illustrates an example of a procedure for graph construction and coloring, in accordance with one aspect of the present disclosure.

FIG. 15 illustrates an example of a procedure for leader and follower selections, in accordance with one aspect of the present disclosure.

FIG. 16 illustrates an example of distributed coordination algorithm, in accordance with one aspect of the present disclosure.

FIG. 17 illustrates a user equipment (UE), according to some implementations.

FIG. 18 illustrates an access node, according to some implementations.

### DETAILED DESCRIPTION

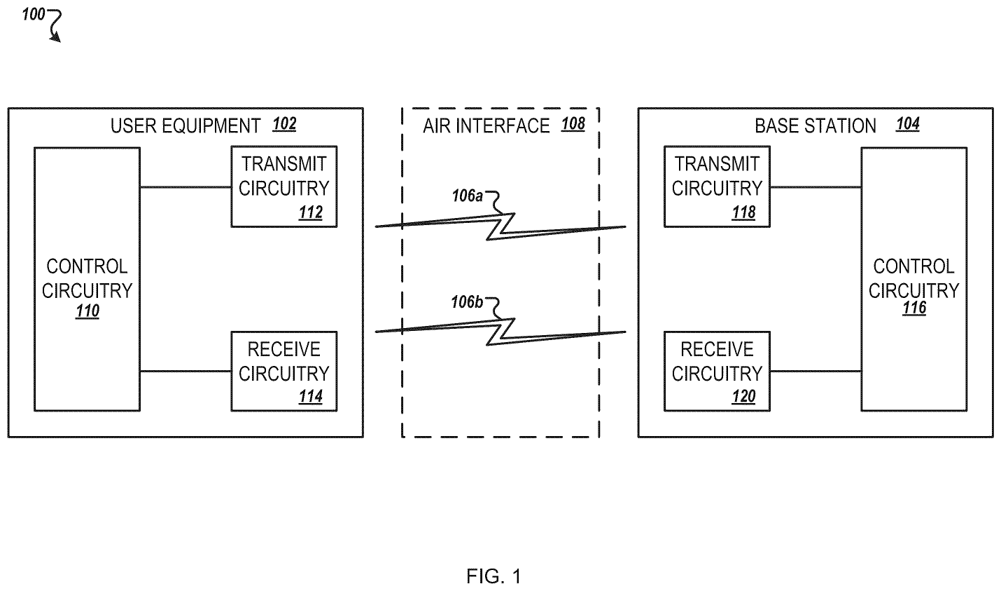

FIG. 1 illustrates a wireless network, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be a E-UTRA (Evolved Universal Terrestrial Radio Access)-NR Dual Connectivity (EN-DC) network, or a NR-EUTRA Dual Connectivity (NE-DC) network. However, the wireless network 100 may also be a Standalone (SA) network that incorporates only SGNR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare, intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations such as those described elsewhere in this disclosure related to a UE.

The transmit circuitry 112 can perform various operations described in this specification. Additionally, the transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. Additionally, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In implementations, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The transmit circuitry 118 may transmit downlink physical channels includes of a plurality of downlink subframes. The receive circuitry 120 may receive a plurality of uplink physical channels from various UEs, including the UE 102.

In FIG. 1, the one or more channels 106A, 106B are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Control Channel (PSCCH), a Physical Sidelink Discovery Channel (PSDCH), and a Physical Sidelink Broadcast Channel (PSBCH).

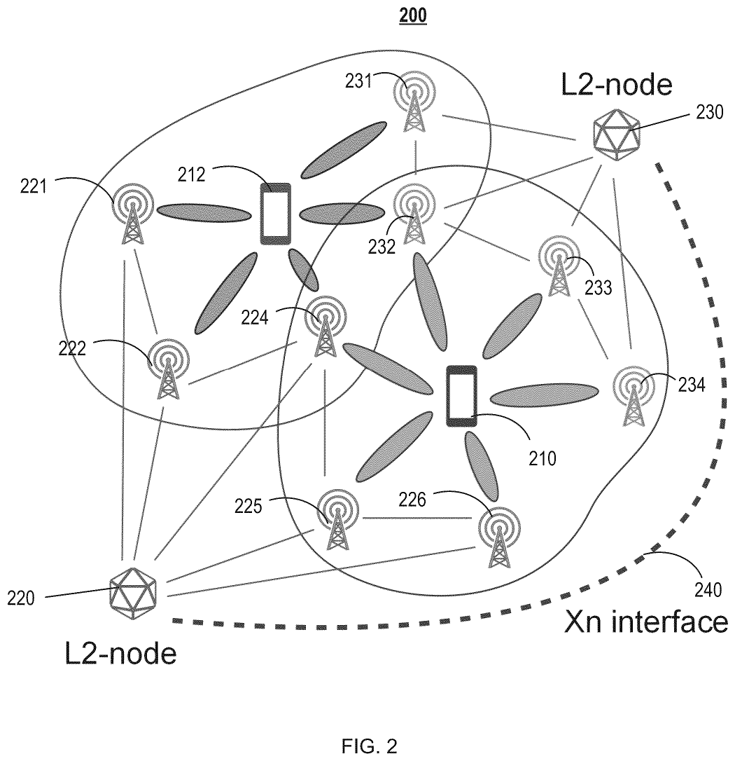

FIG. 2 illustrates an example of a system 200 for cell-free massive MIMO, in accordance with one aspect of the present disclosure. UE 210, 212 may be served by multiple RUs (radio units) 221, 222, 223, 224, 225, 226, 231, 232, 233, 234. These RUs may belong to different L2-nodes 220, 230. For example, the RUs 221, 222, 223, 224, 225, 226 may belong to L2-node 220 and the RUs 231, 232, 233, 234 may belong to L2-node 230. RUs 221, 222, 223, 224, 225, 226, 231, 232, 233, 234, also known as RRHs (remote radio heads), are equipped with antenna arrays (capable to perform DBF or HBF). RUs 221, 222, 223, 224, 225, 226, 231, 232, 233, 234 are responsible for MIMO signal processing, including sounding-based channel estimation, MU DL beamforming and MU UL MIMO combining.

L2-nodes 220, 230 implement at least MAC & RLC functionality, including radio resource allocation algorithm. Depending on the network architecture, L2-node 220, 230 may locate at BBU base station module, at a DU (distributed unit), or at a Mobile Device. L2-nodes are able to use Xn interface 240 (originally designed to assist the handover process) to exchange data and coordinate with each other.

Such a system provides multiple benefits such as, for example, significant reduction of inter-cell interference. Almost all cell-free MIMO scenarios are noise-limited or inaccuracy/impairments-limited, additional beamforming gain due to coherent transmission of multiple antenna arrays, and combined cell-free channel may have higher effective rank

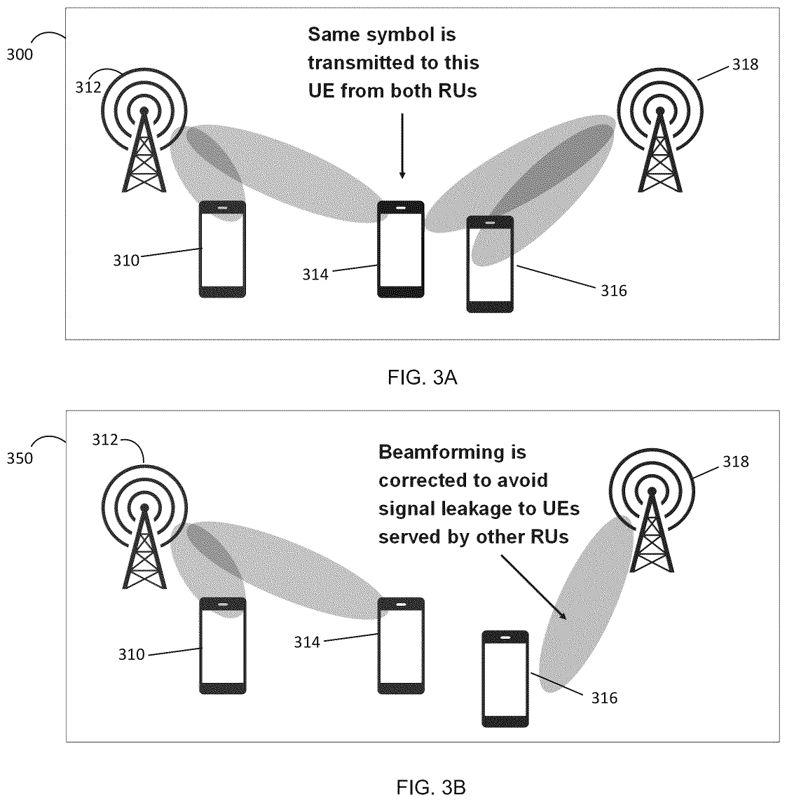

FIG. 3A illustrates an example of a system diagram 300 depicting a type of coordinated beamforming referred to as joint beamforming, in accordance with one aspect of the present disclosure. The system includes RU servicing UE 310 and 314, and RU 318 servicing UE 314 and 316. With joint beamforming: RUs transmit the same data to UEs and jointly optimize the precoding. For example, RU 312 and RU 318 transmit the same symbol to UE 314.

FIG. 3B illustrates an example of a system diagram 350 depicting a type of coordinated beamforming referred to as interference-avoiding beamforming, in accordance with one aspect of the present disclosure. With interference-Avoiding beamforming (aka Coordinated Beamforming): RU 318 (for example) optimizes beamforming for it's own UEs (UE 316 for example) trying to avoid signal leakage to the channel space of the other RU's users.

It is assumed that RUs of the same L2-node always use Joint Beamforming, while RUs of different L2-nodes may adaptively select one of techniques based on the proposed algorithm. Note that at the resource allocation stage, L2-node needs to know which beamforming technique will be used. Thus, the decision on resource allocation and the beamforming technique should be made jointly.

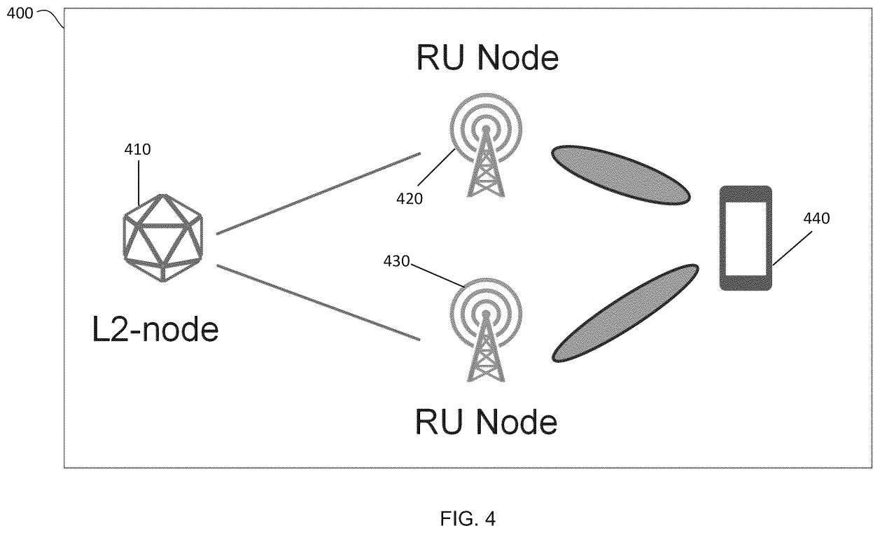

FIG. 4 illustrates an example of a system diagram 400 depicting an example of joint-beamforming with a UE 440 served by a single L2-node 410 and multiple radio units (RUs including first RU 420 and second RU 430), in accordance with one aspect the present disclosure. In this example, a single MAC Scheduler, single MAC instance per UE, single RLC instance per UE. In this case, Joint Beamforming is a PHY layer problem. It is preferable for L2-node 410 to inform its L2-node neighbors about its scheduling decision to support Interference Avoiding beamforming from the neighbor side

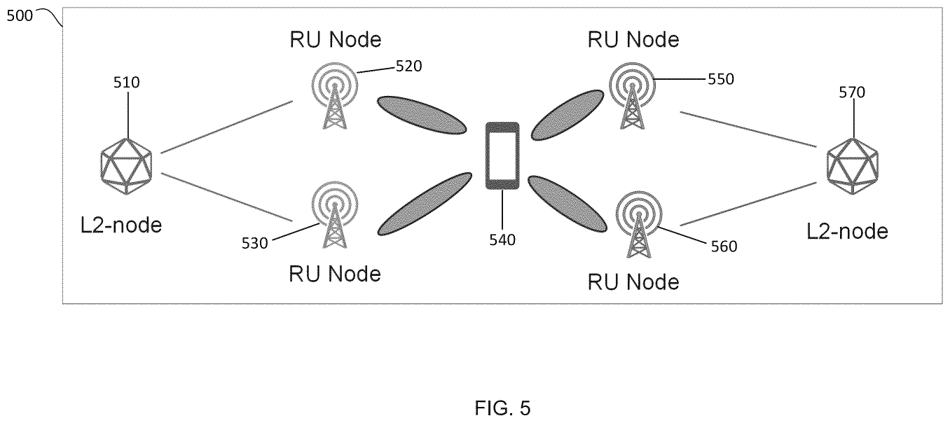

FIG. 5 illustrates an example of a system diagram 500 depicting an example of joint-beamforming with a UE 540 served by multiple L2-nodes (first L2-node 510 and second L2-node 570) and multiple RU (e.g., first RU 520, second RU 530, third RU 550, and fourth RU 560), in accordance with one aspect of the present disclosure. Each L2-node has its own MAC Scheduler, UE has MAC & RLC instance at each L2-node.

Layer 2 Node (L2-node) is defined as a network node implementing the radio resource allocation functionality. E.g., an L2-node could be a Base Station, DU, or Mobile Device in the respective scenarios.

It is assumed that UEs are connected to one or more L2-nodes. The resource allocation is the allocation of DL, UL or SL resources between the UEs.

For each L2-node, its neighborhood & extended neighborhood are defined. Neighborhood of a given L2-node is the set of L2-nodes that may have coordination with a given L2-node when performing resource allocation. Neighborhood is defined for each L2-node by the network, based on proprietary mechanisms. Extended neighborhood of a given L2-node is the union of all neighborhoods of all L2-nodes in the neighborhood of a given L2-node.

It is assumed that L2-nodes are able to exchange the messages within their extended neighborhood using, e.g., Xn interface.

For each L2-node the network assigns an order value. The mechanism for order value assignment could be proprietary and based, e.g., on physical cell ID, specific coloring algorithm, etc. Within every neighborhood, there should be no two L2-nodes with the same order value.

Five types of messages between the L2-nodes to coordinate the resource allocation in distributed manner are shown below in Table 1.

Distributed scheduling solution is described between L2-nodes. It is assumed that measurements (Channel Estimation or its statistics, CSI, CQI) and the input of scheduling algorithm (Buffers and QoS information, priorities, link adaptation offsets) is shared within the neighboring L2-nodes in a near-real-time or periodic manner. In the downlink operation, RLC synchronization and RLC synchronization check is used, since joint beamforming assumes transmission of the same data (with the symbol-level precision) to the UE

The present disclosure provides a set of novel messages used by an L2-node to facilitate distributed coordination between L2 nodes. An overview of the set of novel messages provided by the present disclosure is set forth below in Table 1:

TABLE 1

| Message | Receipients | Trigger | Content |
|---|---|---|---|
| Message Type 1 | Neighborhood | Periodically, and triggered by an | Information about active UEs |
| | | event. | |
| Message Type 2 | Extended neighborhood | Periodically, and triggered by an | Coordination benefit |
| | | event. | estimations |
| Message Type 3 | Extended neighborhood | Periodically at the nodes with the | Leaders and followeres in the |
| | | lowest order value. At other nodes, | neighborhood |
| | | by a specific event. | |
| Message Type 4 | Leaders | Every scheduling period (typically, | Information for scheduling |
| | | every TTI) | |
| Message Type 5 | Followers, optionally | Every scheduling period (typically, | Scheduling result |
| | their neighborhood | every TTI) | |

As shown above, each message type is intended to be distributed to a particular set of recipients, is associated with one or more triggers that cause the message type to be transmitted by an L2-node, and has particular message content. Each of the message types is described in more detail below.

Message Type 1

Messages of Message Type 1 allow L2-nodes perform resource allocation for the neighbor nodes. It also allows to perform coordinated resource allocation for joint UEs. A message of Message Type 1 can be triggered based on one of the following principles (i) pre-configured period or (ii) pre-configured event. A predetermined period can include, e.g., any periodic period of time. A pre-configured event can include, for example, a change of UE state, a novel UE joining the neighborhood, or the like. Messages of Message Type 1 are sent to the following recipients: L2-nodes within the neighborhood. The “neighborhood” can include one or more L2-nodes servicing or connected to one or more UEs.

The content of a Message Type 1 message can include one or more of the following fields:
a list of connected UEs, RRC state,
SRS-based channel measurement information or the estimated covariance matrix of the channel for UEs in RRC active state,
An RLC buffer status for UEs in RRC active state,
HARQ processes information,
a scheduling priority for UEs in RRC active state,
link adaptation offsets for UEs in RRC active state,
CQI for UEs in RRC active state, and/or
a list of RLC PDU IDs or a hash function result of RLC PDU data for the selected UEs.

In some implementations, a Message Type 1 may have all of the aforementioned fields. In some implementations, a Message Type 1 may only have a one or more of the aforementioned fields. In some implementations, the list of RLC PDU Is or a hash function result of RLC PDU data for the selected UEs can be used for RLC synchronization integrity check for jointly served UEs

Message Type 2

Messages of Message Type 2 can provide the information about the potential benefit of coordinated resource allocation. A message of Message Type 2 can be triggered based on one of the following principles: (i) pre-configured period or (ii) a pre-configured event. A predetermined period can include, e.g., any periodic period of time. A pre-configured event can include, for example, a change of UE state, a novel UE joined the neighborhood, or the like. Messages of Message Type 1 are sent to the following recipients: L2-nodes within the neighborhood. Messages of Message Type 2 are sent to the following recipients: L2-nodes within the extended neighborhood

The content of a Message Type 2 may can include one or more of the following fields:
an L2-node order value,
a list of L2-nodes in the neighborhood, and/or
a potential coordination benefit value, calculated for coordination option between the considered L2-node and each of L2-nodes from the neighborhood.

In some implementations, a Message Type 2 may have all of the aforementioned fields. In some implementations, a Message Type 2 may only have a one or more of the aforementioned fields.

The potential coordination benefit value is a value that could take into account, e.g., the number of UEs, priority of UEs, history of service, buffer status, QoS type, application type, expected amount of traffic, spectral efficiency, and the gain of spectral efficiency due to joint beamforming. The design of coordination benefit value is supposed to take into account both efficiency and fairness benefits.

Message Type 3

Messages of Message Type 3 are designed to inform the L2-nodes about the results of leader node selection and the selection of leader-follower relation.

Definition of Leader and Follower: In a given moment of time, each L2-node is either a leader or a follower. Each follower node is led by some leader node. In addition, (i) each follower has only a single leader and (ii) a leader is located in the neighborhood of the follower.

The creation and sending process of message type 3 is triggered in the following manner. In some implementations, a message of Message Type 3 may be periodically triggered. For example, in some implementations, the period can be a pre-configured period T at an L2-node with the lowest order value in its extended neighborhood. Alternatively, or in addition, a message of Message Type 3 can be triggered after an L2-node receives a message of Message Type 3 from every L2-node in the extended neighborhood with a lower order value that the order value of the considered L2-node.

A message of Message Type 3 is sent to the following recipients: L2-nodes within the extended neighborhood.

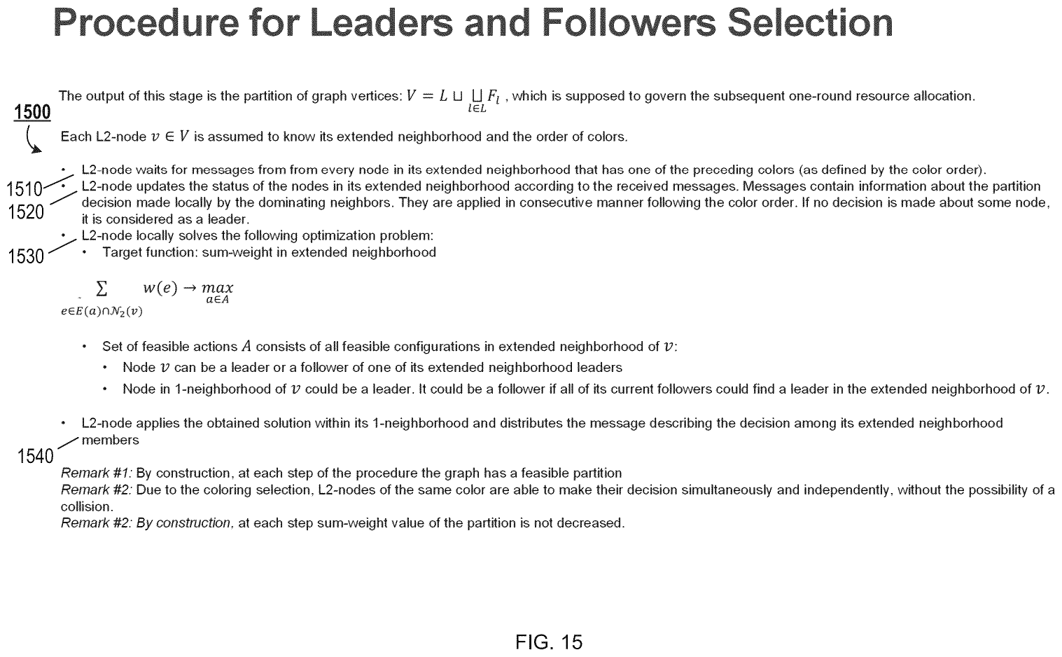

To generate the message of type 3, the L2-node selects leaders and followers within its neighborhood following the rules: (i) leaders and followers selection defined by the received messages of type 3 within the last period T should be preserved, (ii) leaders and followers selection should not violate the definition given above, and (iii) leaders and followers selection should take into account the coordination benefit value, provided by messages of type 2. An example of mathematical optimization problem is given in FIG. 15.

The content of a message of Message Type 3 can include one or more of the following:
an indication of the leader/follower status for each node in the neighborhood and the considered node itself, and/or
for each follower node in the neighborhood, indication of its leader node

In some implementations, a Message Type 3 may have all of the aforementioned fields. In some implementations, a Message Type 3 may only have a one or more of the aforementioned fields.

Message Type 4

Messages of Message type 4 are to be sent by followers to provide their leaders with information used for resource allocation decision. The creation and sending process of messages of type 4 and type 5 is performed every scheduling time period, typically 1 TTI. The message of type 4 is sent by a follower node to its leader L2-node.

The content of a message of Message Type 4 can include one or more of the following:
a list of connected UEs, RRC state,
an RLC buffer status for UEs in RRC active state,
HARQ processes information,
a scheduling priority for UEs in RRC active state,
a link adaptation offsets for UEs in RRC active state, and/or
a relevant CSI information

In some implementations, a Message Type 4 may have all of the aforementioned fields. In some implementations, a Message Type 4 may only have a one or more of the aforementioned fields.

Message Type 5

Messages of Message Type 5 are sent to inform the followers of the considered L2-node about the resource allocation decision. The creation and sending process of messages of type 4 and type 5 is performed every scheduling time period, typically 1 TTI. The message of Message Type 5 is sent by a leader node to the follower L2-nodes.

The of a message of Message Type 5 can include one or more of the following:
a resource allocation, rank, MCS for each UE, and/or
HARQ process indication if HARQ retransmission is scheduled.

In some implementations, a Message Type 5 may have all of the aforementioned fields. In some implementations, a Message Type 5 may only have a one or more of the aforementioned fields.

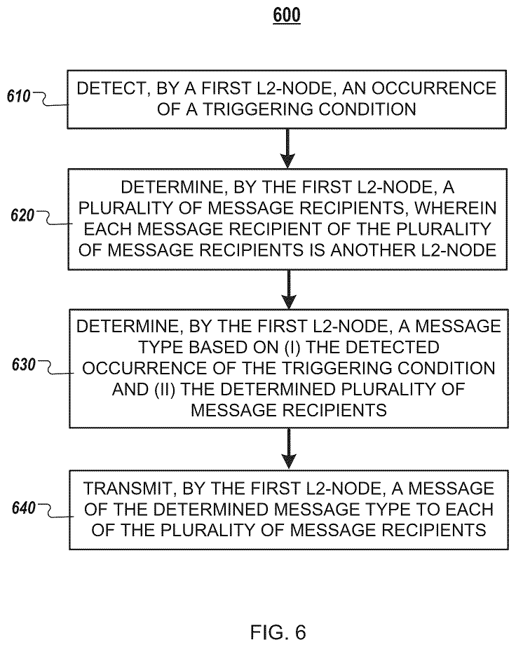

FIG. 6 is a flowchart of an example of a process 600 for distributed coordination between L2 nodes, in accordance with one aspect of the present disclosure. The process 600 is described in more detail below as being performed by an L2-node. An L2-node can be, for example, a base station, a DU, or a UE.

A first L2-node can begin execution of the process 600 by detecting an occurrence of a triggering condition (610).

The first L2-node can continue execution of the process 600 by determining a plurality of message recipients, wherein each message recipient of the plurality of recipients is another L2-node (620).

The first L2-node can continue execution of the process 600 by determining a message type based on (i) the detected occurrence of the triggering condition and (ii) the determined plurality of message recipients (630).

The first L2-node can continue execution of the process 600 by transmitting a message of the determined message type to each of the plurality of message recipients (640).

Message Type 1 Messaging:

In some implementations, the triggering condition is a preconfigured period or a particular triggering event, and the determined plurality of message recipients are L2-nodes within the same neighborhood as the first L2-node. In such implementations, the particular triggering event can include a change of UE state or a novel UE joined the neighborhood.

In some implementations, determining a message type based on (i) the detected occurrence of the triggering condition and (ii) the determined plurality of message recipients by the first L2-node at stage 630 can include the first L2-node selecting a message type that indicates information about active UEs within the neighborhood, wherein the information indicated by the selected message type comprises one or more of the following types of information:
a list of connected UEs, RRC state,
SRS-based channel measurement information or the estimated covariance matrix of the channel for UEs in RRC active state,
an RLC buffer status for UEs in RRC active state,
HARQ processes information,
a scheduling priority for UEs in RRC active state,
link adaptation offsets for UEs in RRC active state,
a CQI for UEs in RRC active state, and/or
a list of RLC PDU IDs or a hash function result of RLC PDU data for the selected UEs.

Message Type 2 Messaging:

In some implementations, the triggering condition is a preconfigured period or a particular triggering event, and the determined plurality of message recipients are L2-nodes within the same extended neighborhood as the first L2-node. In such implementations, the particular triggering event can include a change of UE state or a novel UE joined the extended neighborhood.

In some implementations, determining a message type based on (i) the detected occurrence of the triggering condition and (ii) the determined plurality of message recipients at stage by the first L2-node at stage 630 can include the first L2-node selecting a message type that indicates information about active UEs within the neighborhood, wherein the information indicated by the selected message type comprises one or more of the following types of information:
an L2-node order value,
a list of L2-nodes in the neighborhood, and/or
a potential coordination benefit value.

Message Type 3 Messaging:

In some implementations, the potential coordination benefit value is calculated for a potential coordination option between a considered L2-node and each of L2-nodes from the neighborhood. In such implementations the triggering condition is a (i) a preconfigured period at L2 nodes with a lowest order value or (ii) a predetermined event, and the determined plurality of message recipients are L2-nodes that are leaders and followers in a same neighborhood as the first L2-node. In such implementations, predetermined event is after receipt of a particular message type from every L2-node in the extended neighborhood of the first L2-node with a lower order value than the order value of the first L2-node. In such implementations, the particular message type comprises one or more of the following types of information:

indication of the leader and follower status for each node in the neighborhood and the considered node itself, and
for each follower node in the neighborhood, an indication of its leader node.

In some implementations, determining, by the first L2-node, a message type based on (i) the detected occurrence of the triggering condition and (ii) the determined plurality of message recipients at stage 630 by the L2-node can include the L2-node selecting a message type that indicates information about active UEs within the neighborhood, wherein the information indicated by the selected message type comprises one or more of the following types of information:
indication of the leader and follower status for each node in the neighborhood and the considered node itself, and/or
for each follower node in the neighborhood, an indication of its leader node.

In such implementations, leaders and followers are selected based on a coordinate benefit value provided by another message type. In some implementations, the other message type comprises one or more of the following types of information:
an L2-node order value,
a list of L2-nodes in the neighborhood, and/or
a potential coordination benefit value.

Message Type 4 Messaging:

In some implementations, the triggering condition is every predefined scheduling period, and the determined plurality of message recipients is the indicated leader node of the first L2-node.

In some implementations, determining a message type based on (i) the detected occurrence of the triggering condition and (ii) the determined plurality of message recipients by the first L2-node can include the first L2-node selecting a message type that indicates information about active UEs within the neighborhood, wherein the information indicated by the selected message type comprises one or more of the following types of information:

a list of connected UEs, RRC state,
an RLC buffer status for UEs in RRC active state,
a HARQ processes information,
a scheduling priority for UEs in RRC active state,
a link adaptation offsets for UEs in RRC active state, and/or
a relevant CSI information.

Message Type 5 Messaging:

In some implementations, the triggering condition is every predefined scheduling period, and the determined plurality of message recipients are (i) each follower node within the same neighborhood or (ii) the entire neighborhood of the each follower.

In some implementations, determining a message type based on (i) the detected occurrence of the triggering condition and (ii) the determined plurality of message recipients at by the first L2-node stage 630 can include the first L2-node selecting a message type that indicates information about active UEs within the neighborhood, wherein the information indicated by the selected message type comprises one or more of the following types of information:
resource allocation, rank, MCS for each UE, and/or
a HARQ process indication if HARQ retransmission is scheduled.

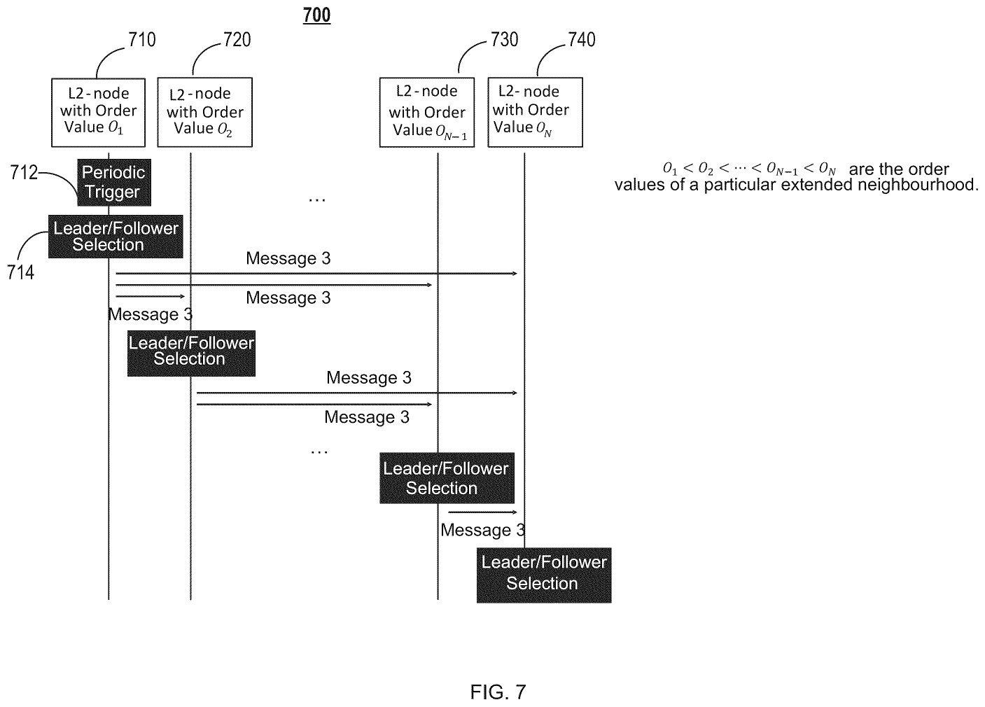

FIG. 7 is a flow diagram 700 of an example of a Message Type 3 exchange, in accordance with one aspect of the present disclosure. FIG. 7 shows a set of L2 nodes with order values from O₁ 710, O₂ 720 . . . O_{N-1} 730, and O_{N} 740. At 712, L2-node with order O₁ 710 can receive or detect a periodic trigger 712. At 714, L2-node with order O₁ 710 can perform leader/follower L2 node selection. In this example, L2-node with order O₁ 710 can send Message 3 signaling to other L2 nodes, each of which can then perform leader/follower selection from the message 3 signaling. Each L2 node can also send high-order L2 nodes message 3 signaling, which the higher order L2 nodes can used to perform leader/follower selection. For example, L2-node with order O₂ 720 can send message 3 signaling to L2-node with order O_{N-1} 730, and L2-node with order O_{N-1} 730 can perform leader/follower selection.

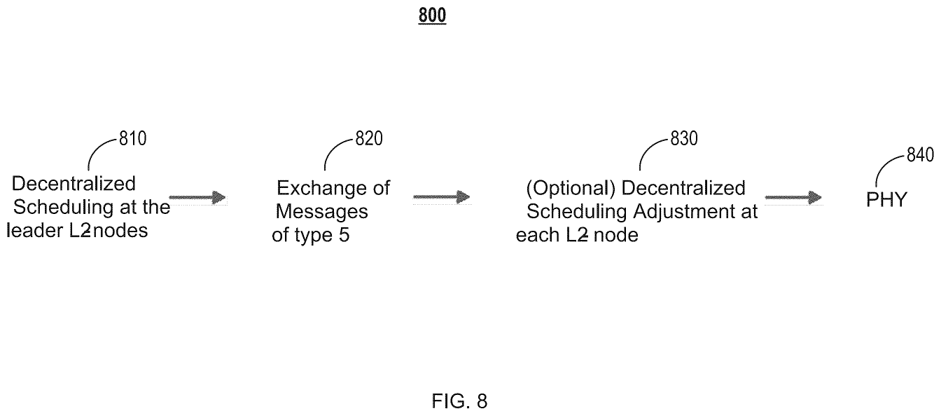

FIG. 8 is an example of a process 800 for scheduling and scheduling adjustment procedures, in accordance with one aspect of the present disclosure.

The process 800 can begins at stage 810 with decentralized scheduling at the leader L2-nodes (810). If L2-node is a leader, then L2-node allocates its own radio resources, scheduling the UEs from the set of controlled UEs. L2-node allocates resources of its followers, scheduling the UEs from the set of controlled UEs. Alternatively, if L2-node is a follower, the follower L2-node just waits for the leader L2-node to get the scheduling decision.

The process 800 continues at stage 820 with the exchange of messages of Message Type 5 (820). Each leader L2-node shares the resource allocation decision of its own resources within its own 1-neighborhood by message type 5 mechanism. Each leader L2-node that allocated resourced of its follower L2-node shares this allocation result with the follower L2-node and the neighbors of the follower L2-node by message type 5 mechanism.

The process 800 can optionally continue at stage 830 by performing decentralized scheduling adjustment at each L2 node (830). At this stage, each L2-node is allowed to make changes in its own resource allocation. The constraints are as follows: L2-node is able to change resource allocation between its own individual UEs: reduce resources allocated to some of them and/or provide more resources for other individual UEs. In some implementations, all joint UEs have to obtain the prescribed resources. Estimated SINR of the joint users should not change during the scheduling adjustment procedure. As an example, L2-node may perform adjustment, taking into account the resource allocation of neighbor nodes, and assuming interference-avoiding beamforming method. The process 800 can then continue to PHY (840).

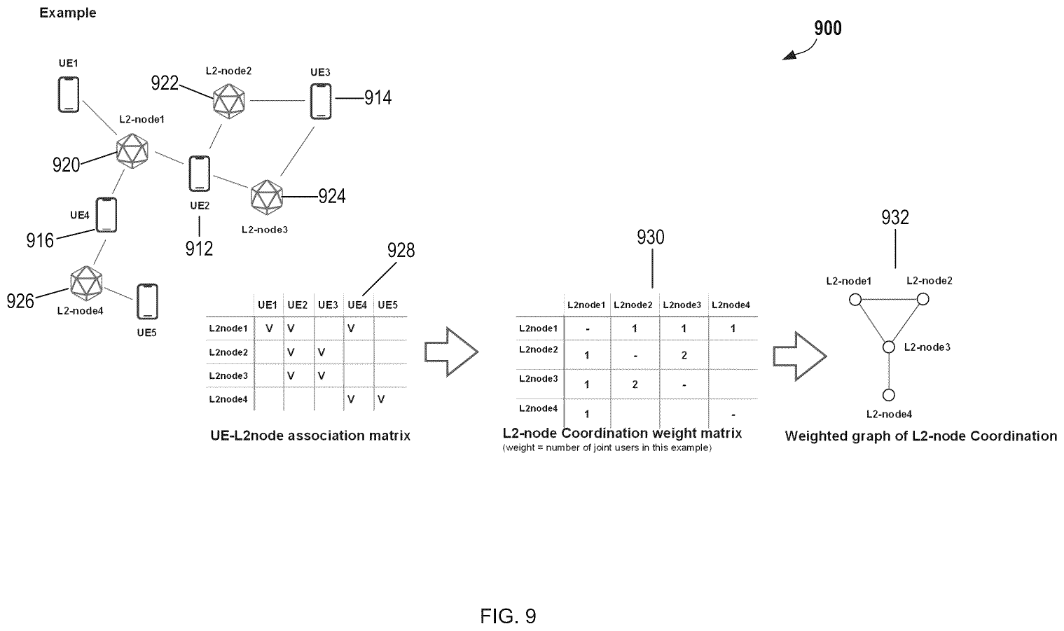

FIG. 9 is a schematic diagram 900 illustrating an example of a graph model for distributed unit (DU) coordination, in accordance with one aspect of the present disclosure. UE is called joint if its RLC is synchronized with two or more L2-nodes. E.g., UE2 912 is being serviced by L2-node1 920, L2-node2 922, and L2-node3 924; UE3 914 is being serviced by L2-node2 922 and L2-node3 924; UE4 916 is being serviced by L2-node1 920 and L2-node4 926. The network is modeled as a weighted undirected graph 932 without loops. Graph vertices of graph 932 correspond to L2-nodes, graph edges correspond to a pair of L2-nodes that have at least one joint UE. Edges might be weighted, where weights indicate the importance of coordination between the L2-nodes. As a simple option, weight could be equal to the number of joint UEs for this two L2-nodes. It is assumed that each L2-node knows its extended neighborhood of this graph (a sub-graph containing all vertices at the distance ≤2 from the considered L2-node and all edges between them).

A UE-L2-node association matrix 928 can be constructed from the network connections. The UE-L2-node association matrix 928 can provide an association between UEs and connected L2-nodes. From the UE-L2-node association matrix 928, an L2-node coordination weight matrix 930 can be constructed. The weights can represent the number of joint users for each L2-node, in this example. Then, the weighted graph 932 of L2-node coordination can be constructed.

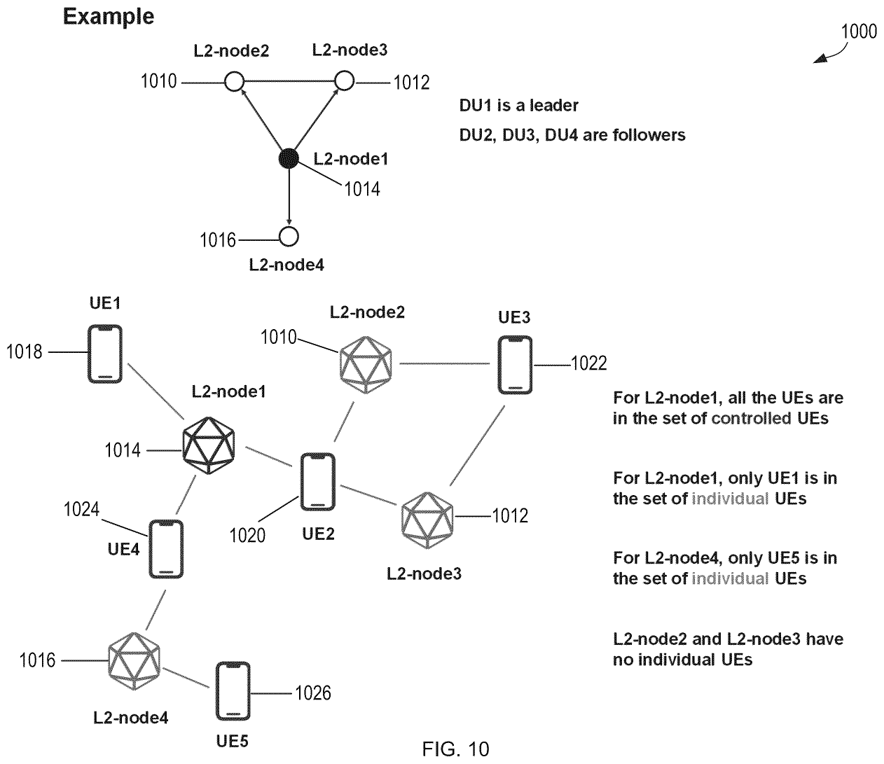

FIG. 10 is a schematic diagram 1000 illustrates definitions for leading and following DUs, in accordance with one aspect of the present disclosure. Assume that each L2-node is either a leader or a follower. Each follower node is led by some leader node. In addition, (i) each follower has only a single leader and (ii) leader is located in the 1-neighborhood of the follower (i.e., there is an edge between them in the coordination graph). In FIG. 10, L2-node 1 (DU1) 1014 is a leader, and L2-node2 (DU2) 1010, L2-node3 (DU3) 1012, and L2-node4 (DU4) 1014 are followers.

Each UE is associated with one or more L2-nodes (based on RLC buffer synchronization). UE1 1018 is associated with DU1 1014; UE2 is associated with DU1 1014, DU2 1010, and DU3 1012; UE3 1022 is associated with DU2 1010 and DU3 1012; UE4 is associated with D1 1014 and DU4 1016; and UE5 is associated with Du4 1016. Moreover, for each UE the primary L2-node is specified within the set of L2-node it is associated with.

For each L2-node, the set of individual UEs is defined as the set of all UEs for which this L2-node is the only one they associated with.

For each Leader L2-node, the set of controlled UEs is identified as the set of all UEs which primary L2-node is the considered leader or one of its follower L2-nodes.

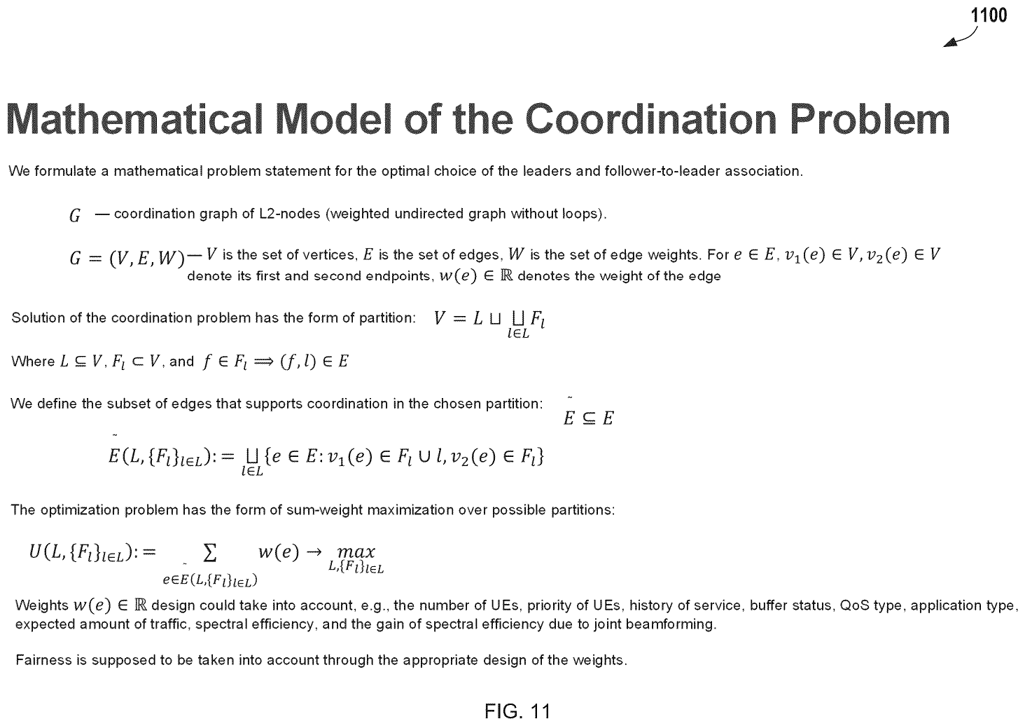

FIG. 11 illustrates a mathematical model of the coordination problem, in accordance with one aspect of the present disclosure. The weights for the graph can be expressed through mathematical expressions. For example, a mathematical problem statement for the optimal choice of the leaders and follower-to-leader association:

G—coordination graphs of L2-nodes (weighted undirected graph without loops).

G=(V,E,W), where V is a set of vertices, E is the set of edges, and W is the set of edge weights.

For e∈E, v1(e) E V, v2(e) E V denote its first and second endpoints, w(e) ∈ [symbol] denotes the weight of the edge. The solution of the coordination problem has the form of partition, V␣U_{(l∈L)} Fl, where l is in the set of L, L is a subset of V and Fl is a proper subset of V, and f is a component of Fl, where (f, l) E Fl.

The subset of edges that supports coordination in the chosen partition can be defined as \tilde{E}⊆E, where \tilde{E}(L, {Fl}_{l∈L}):=␣_{(l∈L)} {e∈E:v1(e) ∈ Fl ∪ l, v2(e) ∈ Fl}.

The optimization problem has the form of sum-weight maximation over possible partitions:

$$U ( L , {\{ Fl \}}_{l ∈ L} ) := {\sum }_{e ∈ \tilde{E} ( L , \{ F l \} l ∈ L )} w ( e ) \to \begin{matrix}max \\ L , \{ F l \} l ∈ L\end{matrix}$$

Weights w(e) E [symbol] design could take into account, e.g., the number of UEs, priority of UEs, history of service, buffer status, QoS type, application type, expected amount of traffic, spectral efficiency, and the gain of spectral efficient due to joint beamforming. Fairness can be taken into account through the appropriate design of the weights.

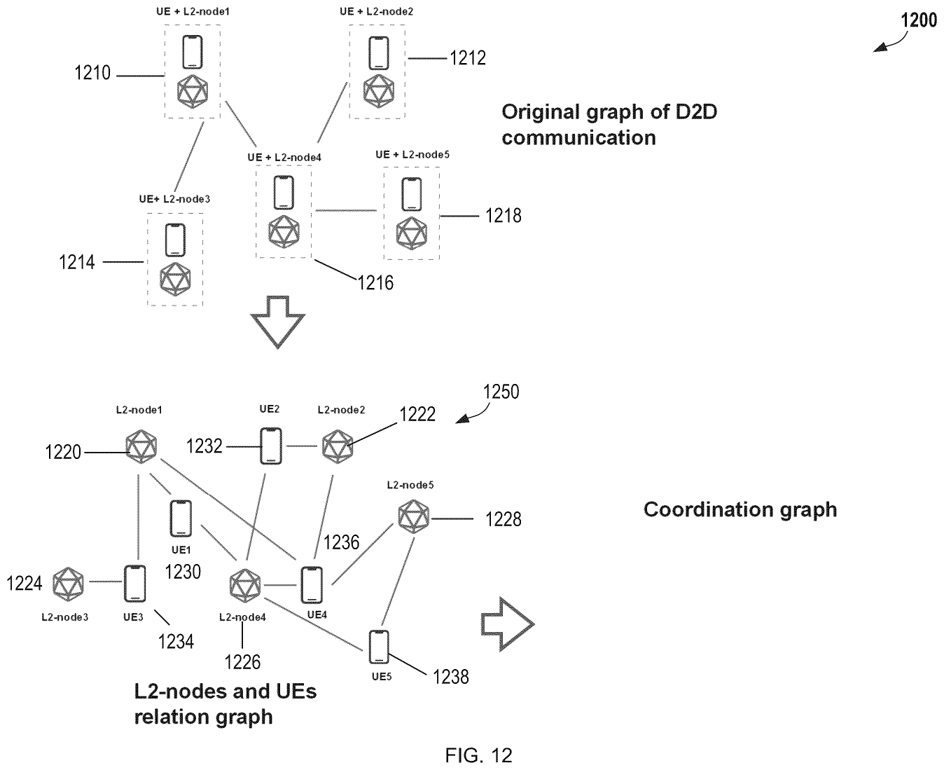

FIG. 12 is a schematic diagram 1200 illustrating an example of distributed coordination in local communications, in accordance with one aspect of the present disclosure. In the case of Local Communication, some mobile devices may implement the L2 functionality and be responsible for scheduling. In this case, L2-node correspond to Master UEs that perform resource allocation functionality. In some embodiments, all UEs may have the L2-node functionality. For example, UE+L2-node1 1210 may perform L2-node functionality. UE+L2-node2 1212 may perform L2-node functionality. UE+L2-node3 1214 may perform L2-node functionality. UE+L2-node4 1216 may perform L2-node functionality. UE+L2-node5 1218 may perform L2-node functionality.

A very similar procedure for distributed coordination can be applied in this case. The original graph of D2D links can be naturally transformed into a graph of L2-nodes and UEs links. Then, based on the proposed method, the coordination graph 1250 can be constructed. The proposed solution provides dynamic UE clustering for mobile devices to coordinate resource allocation, avoid mutual interference and reduce network to device communication overhead. UE1 1230 can be associated with L2-node1 1220 and L2-node4 1226; UE2 1232 can be associated with L2-node2 1222 and L2-node4 1226; UE3 1234 can be associated with L2-node1 1220 and L2-node3 1224; UE4 1236 can be associated with L2-node1 1220, L2-node2 1222, L2-node4 1226, and L2-node5 1228; and UE5 1238 can be associated with L2-node4 1226 and L2-node5 1228.

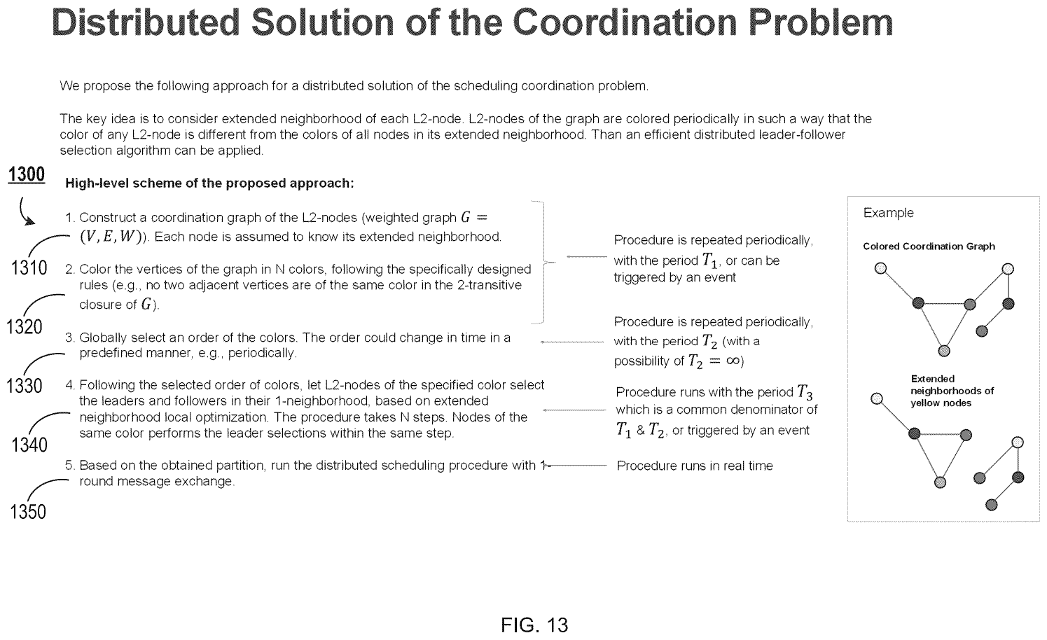

FIG. 13 illustrates an example of a distributed solution 1300 of the coordination problem, in accordance with one aspect of the present disclosure. For example, the distributed solution of the coordination problem comprises a process 1300 comprising stages 1310 to 1350 as shown in FIG. 13. At 1310, a coordination graph of the L2-nodes with weighting is constructed. Each node is assumed to know its extended neighborhood.

At 1320, the vertices are colored or shaded using N colors or shading types. The coloring or shading is specifically designed with rules (e.g., no two adjacent vertices are of the same color in the 2 transitive closer of weighting G). \

Steps 1310 and 1320 are repeated periodically with the period T1 or can be triggered by an event.

At 1330, globally select an order of the colors or shading. The order could change in time in a predefined matter (e.g., periodically). Step 1330 can be repeated periodically with the period T2 (with a possibility that T2=infinity).

At 1340, following the selected order of colors or shading, let L2-nodes of the specified color or shading select the leaders and followers in their 1-neighborhood, based on extended neighborhood local optimization. The procedure takes N steps. Nodes of the same color/shading perform the leader selections within the same step. Step 1340 runs with the period T3, which is a common denominator of T1 and T2, or triggered by an event.

At 1350, based on the obtained partition, the distributed schedule procedure is run with l round of message exchange. Step 1350 runs in real-time.

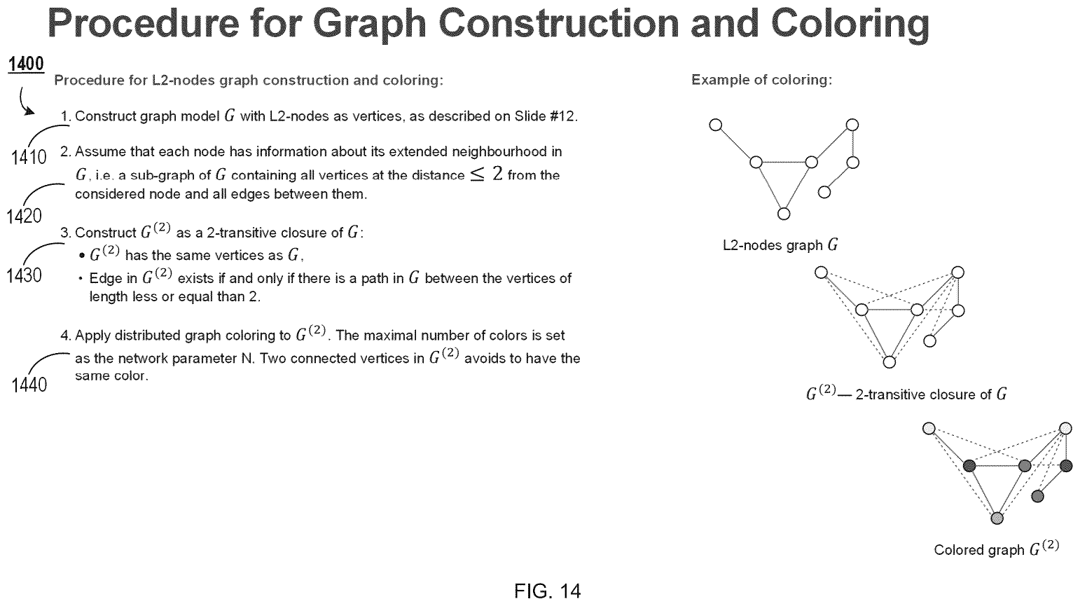

FIG. 14 illustrates an example of a procedure 1400 for graph construction and coloring, in accordance with one aspect of the present disclosure. For example, the graph construction and coloring procedure comprises a process 1400 comprising stages 1410 to 1450 as shown in FIG. 14. Shading can also be used, instead of coloring.

At 1410, a graph model G with L2 nodes as vertices is constructed.

At 1420, the assumption is applied that each node has information about its extended neighborhood in G. That is, a subgraph of G containing all vertices at the distance ≤2 from the considered node and all edges in between.

At step 1430, construct G⁽²⁾ as a 2-transitive closer of G: G⁽²⁾ has the same vertices are G; edges in G⁽²⁾ exist if and only if there is a path in G between the vertices of length less than or equal to 2.

At step 1440, distributed graph color to G⁽²⁾ is applied to the graph. The maximal number of colors is set as the network parameter N. Two connected vertices in G⁽²⁾ avoids to have the same color.

FIG. 15 illustrates an example of a procedure 1500 for leader and follower selections, in accordance with one aspect of the present disclosure. For example, the procedure for leader and follower selections comprises a process 1500 comprising stages 1510-1540 as shown in FIG. 15.

The output of this stage is the partition of graph vertices: V=␣␣(l∈L) Fl, which is supposed to govern the subsequent one-round resource allocation.

Each L2-node v∈V is assumed to know its extended neighborhood and the order of colors.

At 1510, L2-node waits for messages from every node in its extended neighborhood that has one of the preceding colors (as defined by the color order).

At 1520, L2-node updates the status of the nodes in its extended neighborhood according to the received messages. Messages contain information about the partition decision made locally by the dominating neighbors. They are applied in consecutive manner following the color order. If no decision is made about some node, it is considered as a leader.

At 1530, L2-node locally solves the following optimization problem:

Target function: sum-weight in extended neighborhood

$${\sum }_{e ∈ \tilde{E} ( L , \{ F l \} l ∈ L )} w ( e ) \to \begin{matrix}max \\ L , \{ F l \} l ∈ L\end{matrix}$$

The set of feasible actions A consists of all feasible configurations in extended neighborhood of v:

Node v can be a leader or a follower of one of its extended neighborhood leaders

Node in 1-neighborhood of v could be a leader. It could be a follower if all of its current followers could find a leader in the extended neighborhood of v.

At 1540, L2-node applies the obtained solution within its 1-neighborhood and distributes the message describing the decision among its extended neighborhood members

Remark #1: By construction, at each step of the procedure the graph has a feasible partition.

Remark #2: Due to the coloring selection, L2-nodes of the same color are able to make their decision simultaneously and independently, without the possibility of a collision.

Remark #2: By construction, at each step sum-weight value of the partition is not decreased.

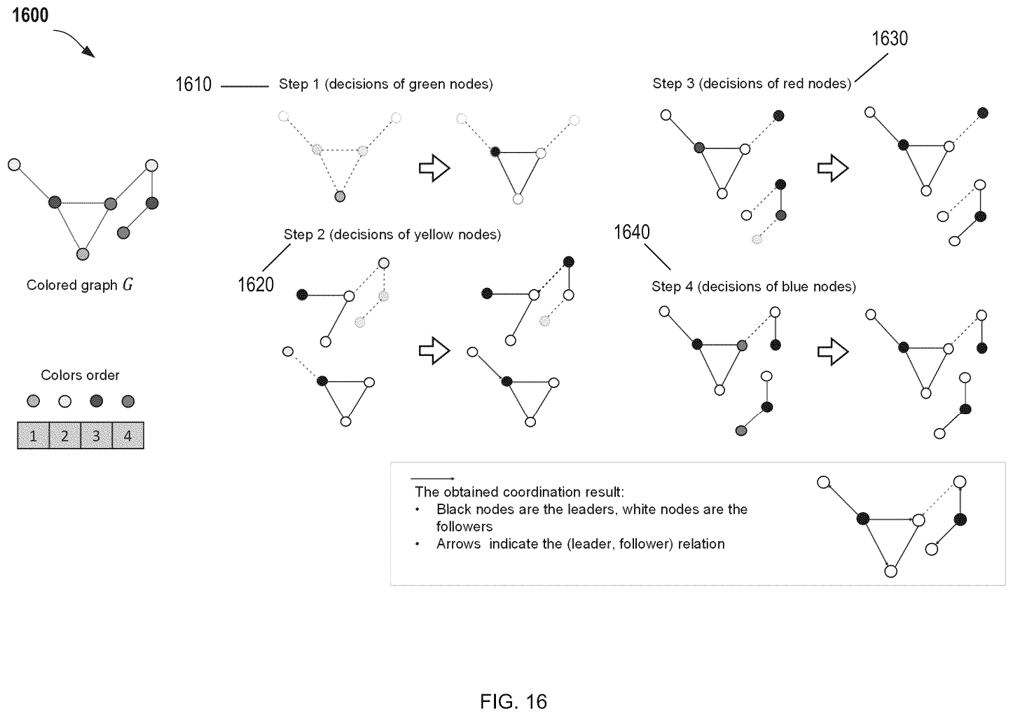

FIG. 16 illustrates an example of distributed coordination algorithm 1600, in accordance with one aspect of the present disclosure. At 1610, first nodes are colored/shaded. At 1620, decisions of second nodes are colored/shaded. At 1630, third nodes are colored/shaded. At 1640, decisions of fourth nodes are colored/shaded.

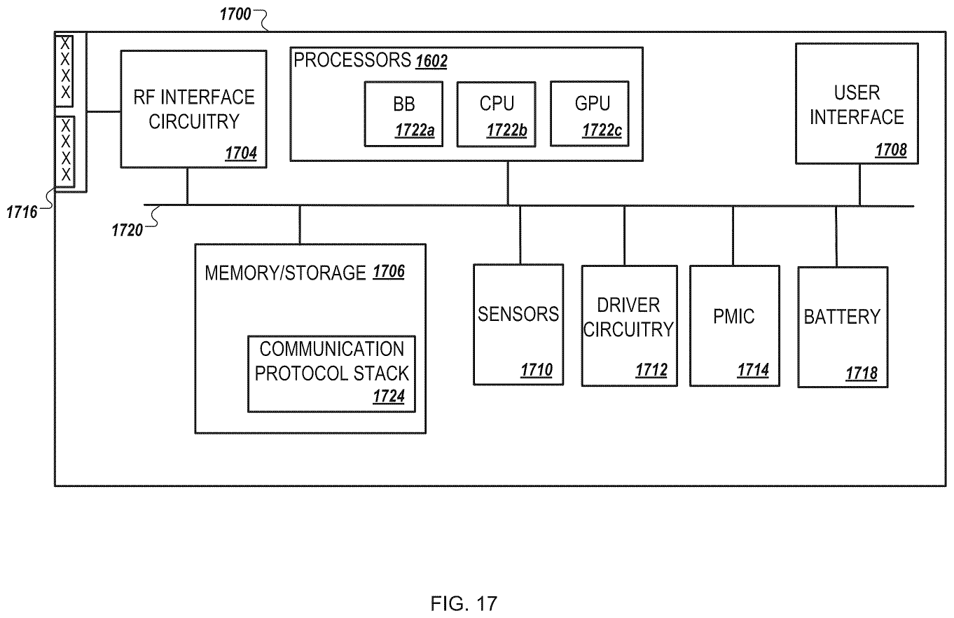

FIG. 17 illustrates a user equipment (UE), according to some implementations. The UE 1700 may be similar to and substantially interchangeable with UE 102 of FIG. 1.

The UE 1700 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 1700 may include processors 1702, RF interface circuitry 1704, memory/storage 1706, user interface 1708, sensors 1710, driver circuitry 1712, power management integrated circuit (PMIC) 1714, antenna structure 1716, and battery 1718. The components of the UE 1700 may be implemented as integrated circuits (ICs), portions thereof, discrete electronic devices, or other modules, logic, hardware, software, firmware, or a combination thereof. The block diagram of FIG. 17 is intended to show a high-level view of some of the components of the UE 1700. However, some of the components shown may be omitted, additional components may be present, and different arrangement of the components shown may occur in other implementations.

The components of the UE 1700 may be coupled with various other components over one or more interconnects 1720, which may represent any type of interface, input/output, bus (local, system, or expansion), transmission line, trace, optical connection, etc. that allows various circuit components (on common or different chips or chipsets) to interact with one another.

The processors 1702 may include processor circuitry such as, for example, baseband processor circuitry (BB) 1722A, central processor unit circuitry (CPU) 1722B, and graphics processor unit circuitry (GPU) 1722C. The processors 1702 may include any type of circuitry or processor circuitry that executes or otherwise operates computer-executable instructions, such as program code, software modules, or functional processes from memory/storage 1706 to cause the UE 1700 to perform operations as described herein.

In some implementations, the baseband processor circuitry 1722A may access a communication protocol stack 1724 in the memory/storage 1706 to communicate over a 3GPP compatible network. In general, the baseband processor circuitry 1722A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 1704. The baseband processor circuitry 1722A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 1706 may include one or more non-transitory, computer-readable media that includes instructions (for example, communication protocol stack 1724) that may be executed by one or more of the processors 1702 to cause the UE 1700 to perform various operations described herein. The memory/storage 1706 include any type of volatile or non-volatile memory that may be distributed throughout the UE 1700. In some implementations, some of the memory/storage 1706 may be located on the processors 1702 themselves (for example, L1 and L2 cache), while other memory/storage 1706 is external to the processors 1702 but accessible thereto via a memory interface. The memory/storage 1706 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1704 may include transceiver circuitry and radio frequency front module (RFEM) that allows the UE 1700 to communicate with other devices over a radio access network. The RF interface circuitry 1704 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1716 and proceed to filter and amplify (with a low-noise amplifier) the signal. The signal may be provided to a receiver of the transceiver that downconverts the RF signal into a baseband signal that is provided to the baseband processor of the processors 1702.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1716. In various implementations, the RF interface circuitry 1704 may be configured to transmit/receive signals in a manner compatible with NR access technologies.

The antenna 1716 may include antenna elements to convert electrical signals into radio waves to travel through the air and to convert received radio waves into electrical signals. The antenna elements may be arranged into one or more antenna panels. The antenna 1716 may have antenna panels that are omnidirectional, directional, or a combination thereof to enable beamforming and multiple input, multiple output communications. The antenna 1716 may include microstrip antennas, printed antennas fabricated on the surface of one or more printed circuit boards, patch antennas, phased array antennas, etc. The antenna 1716 may have one or more panels designed for specific frequency bands including bands in FR1 or FR2.

The user interface 1708 includes various input/output (I/O) devices designed to enable user interaction with the UE 1700. The user interface 1708 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 1700.

The sensors 1710 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1712 may include software and hardware elements that operate to control particular devices that are embedded in the UE 1700, attached to the UE 1700, or otherwise communicatively coupled with the UE 1700. The driver circuitry 1712 may include individual drivers allowing other components to interact with or control various input/output (I/O) devices that may be present within, or connected to, the UE 1700. For example, driver circuitry 1712 may include a display driver to control and allow access to a display device, a touchscreen driver to control and allow access to a touchscreen interface, sensor drivers to obtain sensor readings of sensor circuitry 1710 and control and allow access to sensor circuitry 1710, drivers to obtain actuator positions of electro-mechanic components or control and allow access to the electro-mechanic components, a camera driver to control and allow access to an embedded image capture device, audio drivers to control and allow access to one or more audio devices.

The PMIC 1714 may manage power provided to various components of the UE 1700. In particular, with respect to the processors 1702, the PMIC 1714 may control power-source selection, voltage scaling, battery charging, or DC-to-DC conversion.

In some implementations, the PMIC 1714 may control, or otherwise be part of, various power saving mechanisms of the UE 1700. A battery 1718 may power the UE 1700, although in some examples the UE 1700 may be mounted deployed in a fixed location, and may have a power supply coupled to an electrical grid. The battery 1718 may be a lithium ion battery, a metal-air battery, such as a zinc-air battery, an aluminum-air battery, a lithium-air battery, and the like. In some implementations, such as in vehicle-based applications, the battery 1718 may be a typical lead-acid automotive battery.

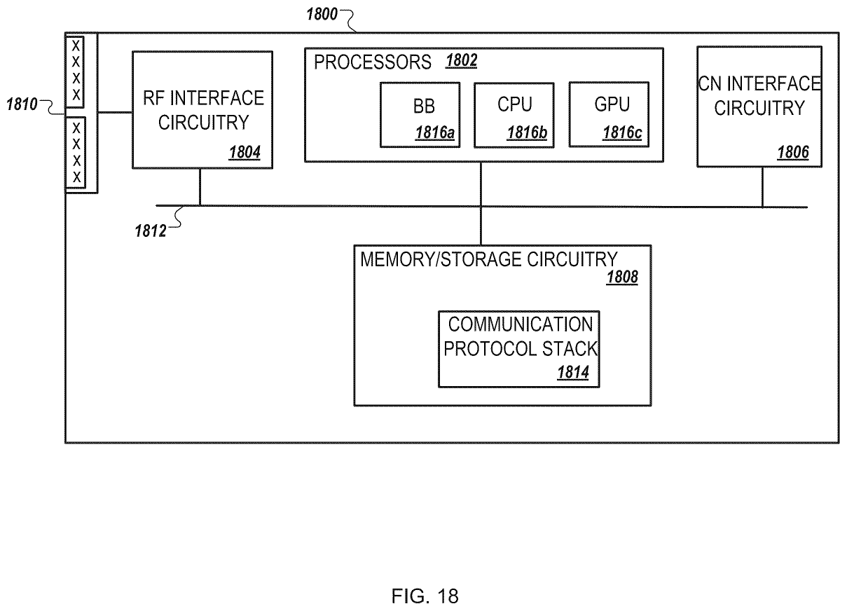

FIG. 18 illustrates an access node 1800 (e.g., a base station or gNB), according to some implementations. The access node 1800 may be similar to and substantially interchangeable with base station 104. The access node 1800 may include processors 1802, RF interface circuitry 1804, core network (CN) interface circuitry 1806, memory/storage circuitry 1808, and antenna structure 1810.

The components of the access node 1800 may be coupled with various other components over one or more interconnects 1812. The processors 1802, RF interface circuitry 1804, memory/storage circuitry 1808 (including communication protocol stack 1814), antenna structure 1810, and interconnects 1812 may be similar to like-named elements shown and described with respect to FIG. 17. For example, the processors 1802 may include processor circuitry such as, for example, baseband processor circuitry (BB) 1816A, central processor unit circuitry (CPU) 1816B, and graphics processor unit circuitry (GPU) 1816C.

The CN interface circuitry 1806 may provide connectivity to a core network, for example, a 5th Generation Core network (5GC) using a 5GC-compatible network interface protocol such as carrier Ethernet protocols, or some other suitable protocol. Network connectivity may be provided to/from the access node 1800 via a fiber optic or wireless backhaul. The CN interface circuitry 1806 may include one or more dedicated processors or FPGAs to communicate using one or more of the aforementioned protocols. In some implementations, the CN interface circuitry 1806 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1800 that operates in an NR or 5G system (for example, a gNB), and the term “E-UTRAN node” or the like may refer to an access node 1800 that operates in an LTE or 4G system (e.g., an eNB). According to various implementations, the access node 1800 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 1800 may be implemented as one or more software entities running on server computers as part of a virtual network, which may be referred to as a CRAN and/or a virtual baseband unit pool (vBBUP). In V2X scenarios, the access node 1800 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

A system, e.g., a base station, an apparatus including one or more baseband processors, and so forth, can be configured to perform particular operations or actions by virtue of having software, firmware, hardware, or a combination of them installed on the system that in operation causes or cause the system to perform the actions.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A method for distributed coordination between L2 nodes, the method comprising:
detecting, by a first L2-node, an occurrence of a triggering condition;
determining, by the first L2-node, a plurality of message recipients, wherein each message recipient of the plurality of recipients is another L2-node;
determining, by the first L2-node, a message type based on (i) the detected occurrence of the triggering condition and (ii) the determined plurality of message recipients; and
transmitting, by the first L2-node, a message of the determined message type to each of the plurality of message recipients.

2. The method of claim 1,
wherein the triggering condition is a preconfigured period or a particular triggering event, and
wherein the determined plurality of message recipients are L2-nodes within the same neighborhood as the first L2-node.

3. The method of claim 2, wherein the particular triggering event can include one of a change of UE state or a novel UE connecting to at least one of the L2-nodes.

4. The method of claim 2, wherein determining, by the first L2-node, a message type based on (i) the detected occurrence of the triggering condition and (ii) the determined plurality of message recipients comprises:
selecting a message type that indicates information about active UEs within the neighborhood, wherein the information indicated by the selected message type comprises one or more of the following types of information:
a list of connected UEs, RRC state,
SRS-based channel measurement information or the estimated covariance matrix of the channel for UEs in RRC active state,
an RLC buffer status for UEs in RRC active state,
HARQ processes information,
a scheduling priority for UEs in RRC active state,
link adaptation offsets for UEs in RRC active state,
a CQI for UEs in RRC active state, and
a list of RLC PDU IDs or a hash function result of RLC PDU data for the selected UEs.

5. The method of claim 1,
wherein the triggering condition is a preconfigured period or a particular triggering event, and
wherein the determined plurality of message recipients are L2-nodes within a same extended neighborhood as the first L2-node.

6. The method of claim 5, wherein the particular triggering event can include a change of UE state or a novel UE joined the extended neighborhood.

7. The method of claim 5, wherein determining, by the first L2-node, a message type based on (i) the detected occurrence of the triggering condition and (ii) the determined plurality of message recipients comprises:
selecting a message type that indicates information about active UEs within the neighborhood, wherein the information indicated by the selected message type comprises one or more of the following types of information:
an L2-node order value,
a list of L2-nodes in the neighborhood, and
a potential coordination benefit value.

8. The method of claim 5, wherein the potential coordination benefit value is calculated for a potential coordination option between a considered L2-node and each of L2-nodes from the neighborhood.

9. The method of claim 1,
wherein the triggering condition is a (i) a preconfigured period at L2 nodes with a lowest order value or (ii) a predetermined event, and
wherein the determined plurality of message recipients are L2-nodes that are leaders and followers in a same neighborhood as the first L2-node.

10. The method of claim 9, wherein the predetermined event is after receipt of a particular message type from every L2-node in the extended neighborhood of the first L2-node with a lower order value than the order value of the first L2-node.

11. The method of claim 10, wherein the particular message type comprises one or more of the following types of information:
indication of the leader and follower status for each node in the neighborhood and the considered node itself, and
for each follower node in the neighborhood, an indication of its leader node.

12. The method of claim 9, wherein determining, by the first L2-node, a message type based on (i) the detected occurrence of the triggering condition and (ii) the determined plurality of message recipients comprises:
selecting a message type that indicates information about active UEs within the neighborhood, wherein the information indicated by the selected message type comprises one or more of the following types of information:
indication of the leader and follower status for each node in the neighborhood and the considered node itself, and
for each follower node in the neighborhood, an indication of its leader node.

13. The method of claim 9, wherein leaders and followers are selected based on a coordinate benefit value provided by another message type.

14. The method of claim 13, wherein the other message type comprises one or more of the following types of information:
an L2-node order value,
a list of L2-nodes in the neighborhood, and
a potential coordination benefit value.

15. The method of claim 1,
wherein the triggering condition is every predefined scheduling period, and
wherein the determined plurality of message recipients is the indicated leader node of the first L2-node.

16. The method of claim 15, wherein determining, by the first L2-node, a message type based on (i) the detected occurrence of the triggering condition and (ii) the determined plurality of message recipients comprises:
selecting a message type that indicates information about active UEs within the neighborhood, wherein the information indicated by the selected message type comprises one or more of the following types of information:
a list of connected UEs, RRC state,
an RLC buffer status for UEs in RRC active state,
a HARQ processes information,
a scheduling priority for UEs in RRC active state,
a link adaptation offsets for UEs in RRC active state, and
a relevant CSI information.

17. The method of claim 1,
wherein the triggering condition is every predefined scheduling period, and
wherein the determined plurality of message recipients are (i) each follower node within the same neighborhood or (ii) the entire neighborhood of the each follower.

18. The method of claim 17, wherein determining, by the first L2-node, a message type based on (i) the detected occurrence of the triggering condition and (ii) the determined plurality of message recipients comprises:
selecting a message type that indicates information about active UEs within the neighborhood, wherein the information indicated by the selected message type comprises one or more of the following types of information:
resource allocation, rank, MCS for each UE, and
a HARQ process indication if HARQ retransmission is scheduled.

19. One or more processors comprising circuitry to execute one or more instructions that, when executed, cause an L2-node to perform the operations comprising:
detecting, by a first L2-node, an occurrence of a triggering condition;
determining, by the first L2-node, a plurality of message recipients, wherein each message recipient of the plurality of recipients is another L2-node;
determining, by the first L2-node, a message type based on (i) the detected occurrence of the triggering condition and (ii) the determined plurality of message recipients; and
transmitting, by the first L2-node, a message of the determined message type to each of the plurality of message recipients.

20. An L2-node comprising:
one or more processors; and
one or more memory devices storing instructions that, when executed, cause the one or more processors to perform the operations comprising:
detecting, by a first L2-node, an occurrence of a triggering condition;
determining, by the first L2-node, a plurality of message recipients, wherein each message recipient of the plurality of recipients is another L2-node;
determining, by the first L2-node, a message type based on (i) the detected occurrence of the triggering condition and (ii) the determined plurality of message recipients; and
transmitting, by the first L2-node, a message of the determined message type to each of the plurality of message recipients.
